(19) United States
(12) Patent Application Publication
(10) Pub. No.: US 2018/0101353 A1
(43) Pub. Date: Apr. 12, 2018

(54) Method and system to control musical playback from a human Disc Jockey

(71) Applicant: Eric J. Flores, Santa Clarita, CA (US)

(72) Inventor: Eric J. Flores, Santa Clarita, CA (US)

(21) Appl. No.: 15/289,047

(22) Filed: Oct. 7, 2016

(51) Int. Cl. G06F 3/16; G07C 13/00

(52) U.S. Cl. CPC G06F 3/165; G10H 2240/131; G07C 13/00

(57) ABSTRACT

The system for interactively controlling musical playback from a human Disc Jockey (DJ) by retrieving audience feedback, resides on a central computer having a processor installed with a DJ musical playback software application and coupled with a memory unit integrated with a central database. The central computer executes a computer readable program code embodied in a non-transitory computer-readable medium. The computer readable program code includes a set of instructions for executing a method for interactively controlling musical playback from a human DJ by retrieving feedback from a remote as well as an onsite audience. The DJ musical playback control system further comprising, a DJ interface module, a DJ music style listing module, a DJ choice presenting module, a DJ music timer module, an onsite audience interface module, a remote audience interface module, a vote tallying module and a winner display module.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

The present disclosure relates generally to interactive control of musical playback from a live performing Disc Jockey (DJ). More specifically, the present disclosure relates to a system and method for controlling, influencing and altering the type of music to be played by a live performing human Disc Jockey in accordance with audience preference.

### DISCUSSION OF RELATED ART

For many years, millions of people around the world have enjoyed listening to their favourite DJ's musical performances which includes performing, playing, and mixing their preferred tunes and other popular music. Live DJ musical performances will continue to draw in large audiences at concerts, music festivals, dance clubs, trendy bars, restaurants and other entertainment venues including wedding receptions. A critical element for a successful DJ is to know what type of music would be appealing to a crowd of people based on the occasion and the common culture, style or age groups present. It is often challenging for a DJ to determine what tune the audience would like to hear next, as listeners can number into hundreds or even thousands and the mood of the audience can change when new crowd members arrive.

The conventional methods of playing to the audience include the audience verbally conveying their likes or dislikes to the music played, but it is difficult for the DJs to determine what the entire audience wants to hear versus a vocal few. Electronic voting then emerged to determine the favorite music for a particular audience. This enables the audience to electronically submit a vote for a specific type of music that the DJ has available for playback. One such method includes a software application configured to enable a single controller trigger to send arbitrarily complex sequences of keystroke and/or MIDI control messages to a multimedia device or a DJ player. Each trigger of the controller can be uniquely programmed to generate a complex sequence of keystrokes and/or MIDI control messages, allowing more complex and higher performance control of the multi-media device.

Although this is an improvement, this method is not flexible and may not summarize what the majority demands. Therefore, there is a need for a system and method that enables audience members to electronically the musical playback of a live performing DJ. Such a method should provide the audience the facility to electronically convey their preferred tunes to the DJ and thereby enabling the DJ to control his/her performance according to the audience taste. Such a needed application would assist the DJ to know what music to play next for the current audience of listeners by surmising what type of music would be appealing to a particular crowd of people based on the occasion and the common culture, style or age groups present. This method would provide a simple and easy way for any DJ or live performing musician to target their performance to a particular audience. Moreover this application would further allow live performing DJs to accurately determine the musical demand of a large audience according to the mood, environmental setting, cultural preferences or other circumstances that may be influential. The present embodiment overcomes prior art shortcomings by accomplishing these critical objectives.

### SUMMARY OF THE DISCLOSURE

To minimize the limitations found in the prior art, and to minimize other limitations that will be apparent upon the reading of the specification, the present invention is a system and method for interactive control of musical playback from a live performing Disc Jockey (DJ) by retrieving audience feedback. In the preferred embodiment, a DJ musical playback control system is in communication with a DJ control station and a plurality of voting kiosk consoles via a communication network. The plurality of voting kiosk consoles includes an onsite voting kiosk console and a remote voting kiosk console. The DJ control station, the remote voting kiosk console and the onsite voting kiosk console are selected from a group consisting of: a smart phone, a laptop, a tablet computer, a personal computer and a digital media communication device. The DJ musical playback control system resides on a central computer having a processor installed with a DJ musical playback software application and coupled with a memory unit integrated with a central database. The DJ musical playback control system further comprising, a DJ interface module, a DJ music style listing module, a DJ choice presenting module, a DJ music timer module, an onsite audience interface module, a remote audience interface module, a vote tallying module and a winner display module.

The method initiates by enabling the DJ to log into a DJ musical playback software application utilizing the DJ interface module through the DJ control station. Upon successful login the DJ music style listing module allows the DJ to add or remove musical styles and genres to present at least one choice of available music for an onsite audience and a remote audience. The presented choices of available music are specifically identified by the name of the music or by the name of the artist and are displayed as graphical images behind text or as text captioned on top of graphical images wherein graphical images and text can be altered, modified, processed, still-framed, or animated. Further the DJ choice presenting module at the processor presents the choice of available music before the onsite audience and the remote audience through the onsite voting kiosk console and the remote voting kiosk console respectively. As the method advances the DJ music timer module enables the DJ to set a voting session for the onsite audience and the remote audience utilizing the DJ control station. The voting session can be initiated by manually or touch screen tapping on the “Begin voting” button on the DJ control station. The DJ musical playback control system further includes a digital or electrical power signal outputted and controlled by the DJ musical playback software application that allows for the activation or de-activation of recorded or generated sounds, external lighting such as rotating beacons, strobes, digital or powered signs, or any other signal for informing the onsite audience of when the votes are being taken by the system. As the voting session begins, the onsite audience interface module and the remote audience interface module allows the onsite audience and the remote audience to vote for at least one music style from the presented choices of available music through the onsite voting kiosk console and the remote voting kiosk console respectively. The DJ can add or subtract the total session time needed for voting utilizing a voting session length timer. When the voting session ends, the votes are automatically tallied to find the voting rates of each of the presented choice of available music utilizing the vote tallying module and a winner display module display at least one winner playlist with highest voting rates to the DJ, the remote audience and the onsite audience through the DJ control station, the remote voting kiosk console and the onsite voting kiosk console respectively. If no votes are received from the onsite audience and the remote audience for the presented choice of available music, the DJ initiates a next voting session for an alternate choice of available music and the process repeats until the DJ performance ends.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is an exemplary computer network environment that is used in a system and method for interactively controlling musical playback from a human DJ by retrieving audience feedback in accordance with a preferred embodiment of the present invention;

FIG. 2 is a high-level block diagram of a DJ musical playback control system illustrated in the computing environment of FIG. 1 in accordance with a preferred embodiment of the present invention;

FIG. 3 is an operational flowchart illustrating a method for interactively controlling musical playback from a human DJ by retrieving audience feedback in accordance with the present invention;

FIG. 4 is a screenshot illustrating a welcome screen for the DJ while he/she opening a DJ musical playback software application utilizing a DJ control station of the present invention;

FIG. 5 is a screenshot illustrating a login screen for the DJ after he/she clicks on a “DJ login” icon in the welcome screen of the DJ musical playback software application of the present invention;

FIG. 6 is a screenshot illustrating the DJ control station screen after the successful login of the DJ in accordance with the present invention;

FIG. 7 is a screenshot illustrating a welcome screen for the audience after he/she successfully logs into the DJ musical playback software application utilizing a plurality of voting kiosk consoles in accordance with the present invention;

FIGS. 8 and 9 are screenshots illustrating the plurality of voting kiosk console screens during the voting session in accordance with the present invention;

FIG. 10 is a screenshot illustrating the plurality of voting kiosk console screens while displaying at least one winner playlist in accordance with the present invention;

FIG. 11 is a screenshot illustrating the DJ control station screens while displaying at least one winner playlist in accordance with the present invention; and

FIG. 12 is a screenshot illustrating the plurality of voting kiosk console screens while playing a winner playlist with highest voting rates in accordance with the present invention in accordance with the present invention and displaying a graphical or text name banner representing the music currently being played along with a themed or non-themed animation or graphic.

### DETAILED DESCRIPTION OF THE PREFERRED EMBODIMENT

In the following discussion that addresses a number of embodiments and applications of the present invention, reference is made to the accompanying drawings that form a part hereof, and in which is shown by way of illustrating specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The invention will now be described with reference to the accompanying drawing which does not limit the scope and the ambit of the invention.

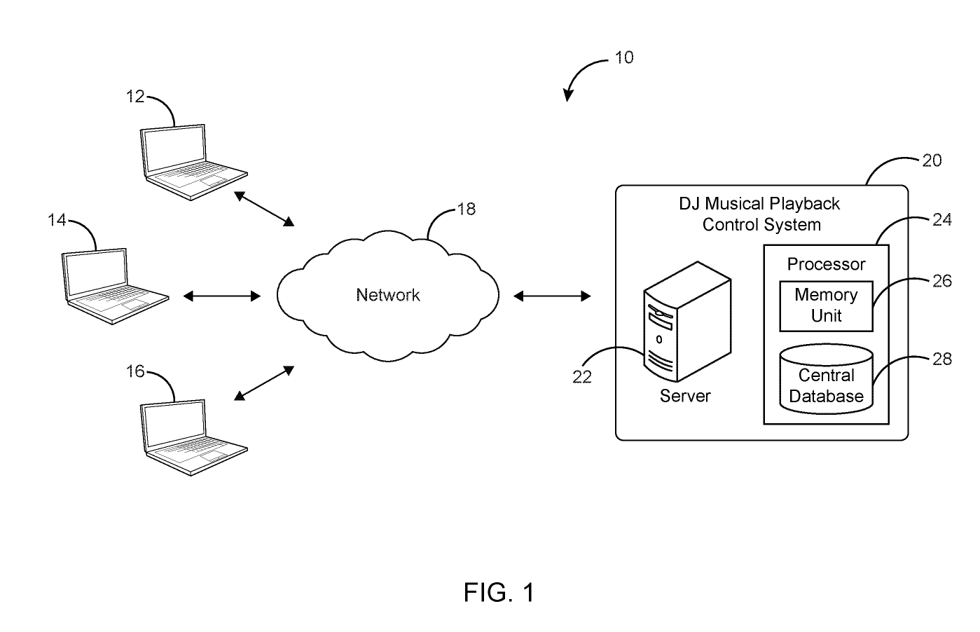

FIG. 1 is an exemplary computer network environment that is used in a system and method for interactively controlling musical playback from a human Disc Jockey (DJ) by retrieving audience feedback in accordance with a preferred embodiment of the present invention. The computer network environment 10 includes a communication network 18 such as the Internet which interconnects a DJ musical playback control system 20 with a DJ control station 12 associated with a DJ and a plurality of voting kiosk consoles 14 and 16 associated with an audience. The plurality voting kiosk consoles 14 and 16 include a remote voting kiosk console 14 associated with a remote audience and an onsite voting kiosk console 16 associated with an onsite audience. The DJ control station 12, the remote voting kiosk console 14 and the onsite voting kiosk console 16 are selected from a group consisting of: a smart phone, a laptop, a tablet computer, a personal computer and a digital media communication device.

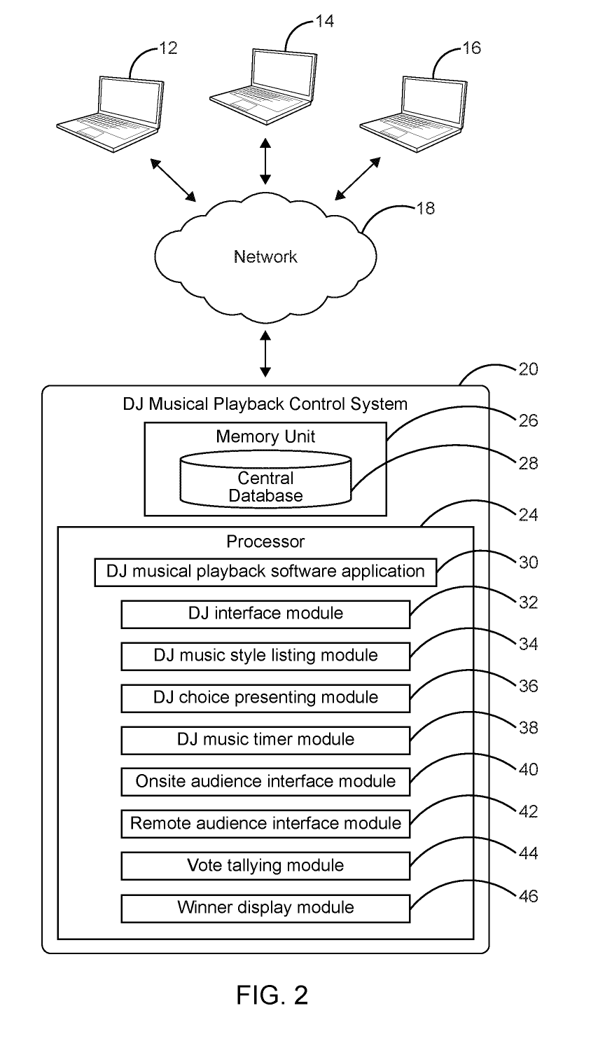

Referring to FIG. 2, a high-level block diagram of the DJ musical playback control system 20 illustrated in the computing environment of FIG. 1 in accordance with a preferred embodiment of the present invention is depicted. The DJ musical playback control system 20 resides on a central computer having a processor 24 installed with a DJ musical playback software application 30 and coupled with a memory unit 26 integrated with a central database 28. The DJ musical playback software application 30 may be a mobile application, a desktop computer application, an embedded software program, or any other type of software application that runs on the processor 24 of the central computer. In one embodiment of the present invention, the central computer is a server system. The DJ musical playback control system further comprising, a DJ interface module 32, a DJ music style listing module 34, a DJ choice presenting module 36, a DJ music timer module 38, an onsite audience interface module 40, a remote audience interface module 42, a vote tallying module 44 and a winner display module 46. The central computer executes a computer readable program code embodied in a non-transitory computer-readable medium. The computer readable program code includes a set of instructions for executing a method for interactively controlling musical playback from a human DJ by retrieving feedback from a remote as well as an onsite audience.

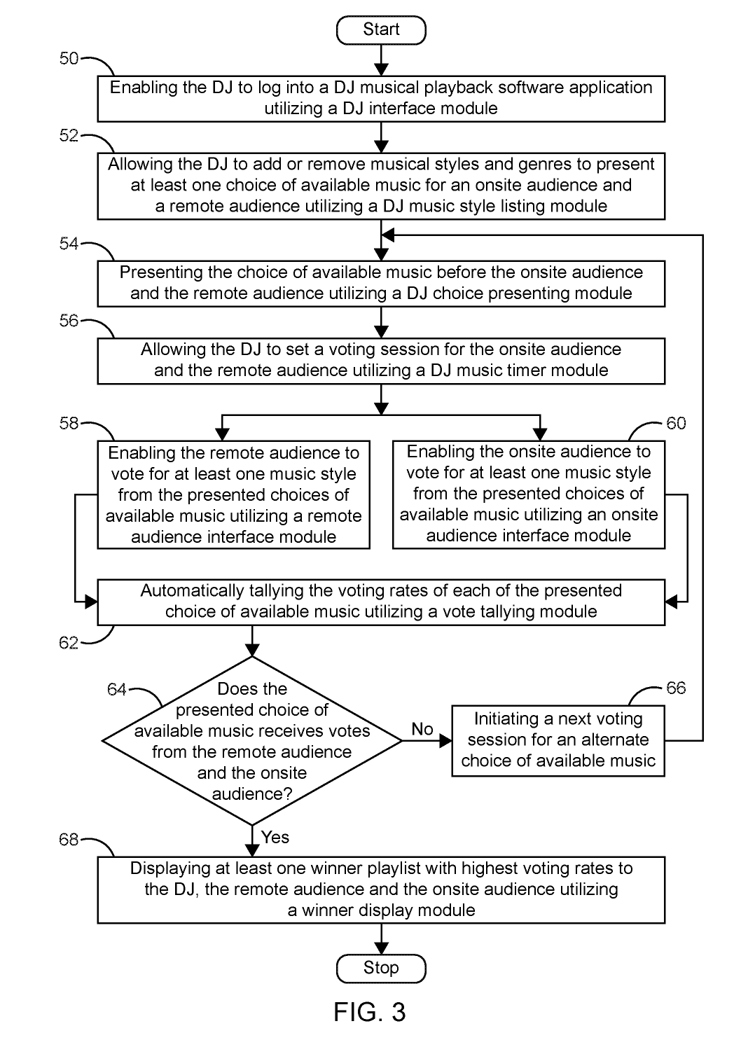

FIG. 3 is an operational flowchart illustrating a method for interactively controlling musical playback from a human DJ by retrieving audience feedback in accordance with the present invention. The method initiates by enabling the DJ to log into the DJ musical playback software application utilizing the DJ interface module through the DJ control station as indicated in block 50. Upon successful login the DJ music style listing module allows the DJ to add or remove musical styles and genres to present at least one choice of available music for the onsite audience and the remote audience as indicated in block 52. The presented choices of available music are specifically identified by the name of the music or by the name of the artist and are displayed as graphical images behind text or as text captioned on top of graphical images wherein graphical images and text can be altered, modified, processed, still-framed, or animated. Further the DJ choice presenting module at the processor presents the choice of available music before the onsite audience and the remote audience through the onsite voting kiosk console and the remote voting kiosk console respectively as shown in block 54. As the method advances the DJ music timer module enables the DJ to set a voting session for the onsite audience and the remote audience utilizing the DJ control station as depicted in block 56. The voting session can be initiated by manually or touch screen tapping on the “Begin voting” button on the DJ control station 12. The DJ musical playback control system 20 further includes a digital or electrical power signal outputted and controlled by the DJ musical playback software application 30 that allows for the activation or de-activation of recorded or generated sounds, external lighting such as rotating beacons, strobes, digital or powered signs, or any other signal for informing the onsite audience of when the votes are being taken by the system 20. As the voting session begins, the onsite audience interface module and the remote audience interface module allows the onsite audience and the remote audience to vote for at least one music style from the presented choices of available music through the onsite voting kiosk console and the remote voting kiosk console respectively as indicated in blocks 58 and 60. The DJ can then add or subtract voting session timers to fine tune the total session time needed for voting according to his/her wish. When the voting session ends, the votes are automatically tallied to find the voting rates of each of the presented choice of available music utilizing the vote tallying module and a winner display module display at least one winner playlist with highest voting rates to the DJ, the remote audience and the onsite audience through the DJ control station, the remote voting kiosk console and the onsite voting kiosk console respectively as shown in blocks 62, 64, and 68. If no votes were received from the onsite audience and the remote audience for the presented choice of available music, the DJ initiates a next voting session for an alternate choice of available music as indicated in block 66 and the process repeats until the DJ performance ends.

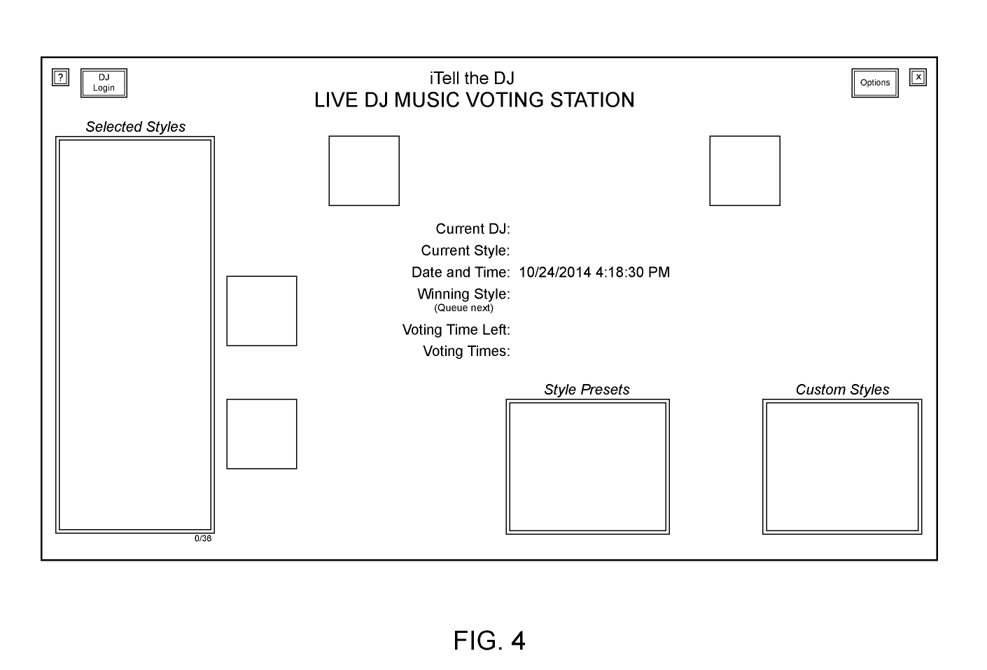

FIG. 4 is a screenshot illustrating a welcome screen for the DJ while he/she opening the DJ musical playback software application 30 utilizing the DJ control station 12 of the present invention. The welcome screen includes a DJ login icon at the top on which the DJ has to click for logging into the DJ musical playback software application 30.

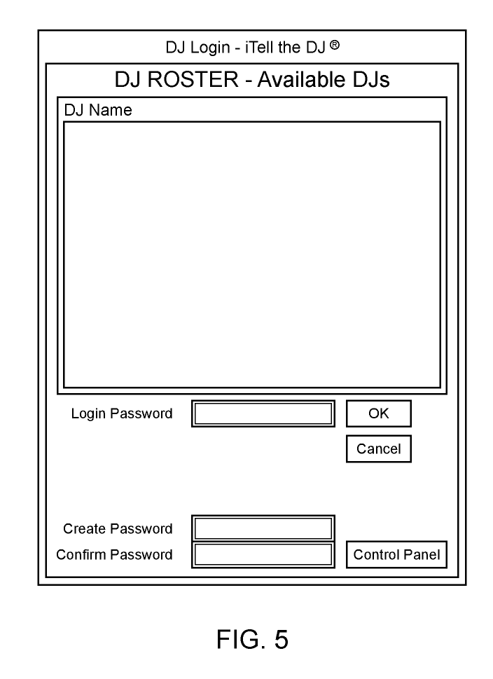

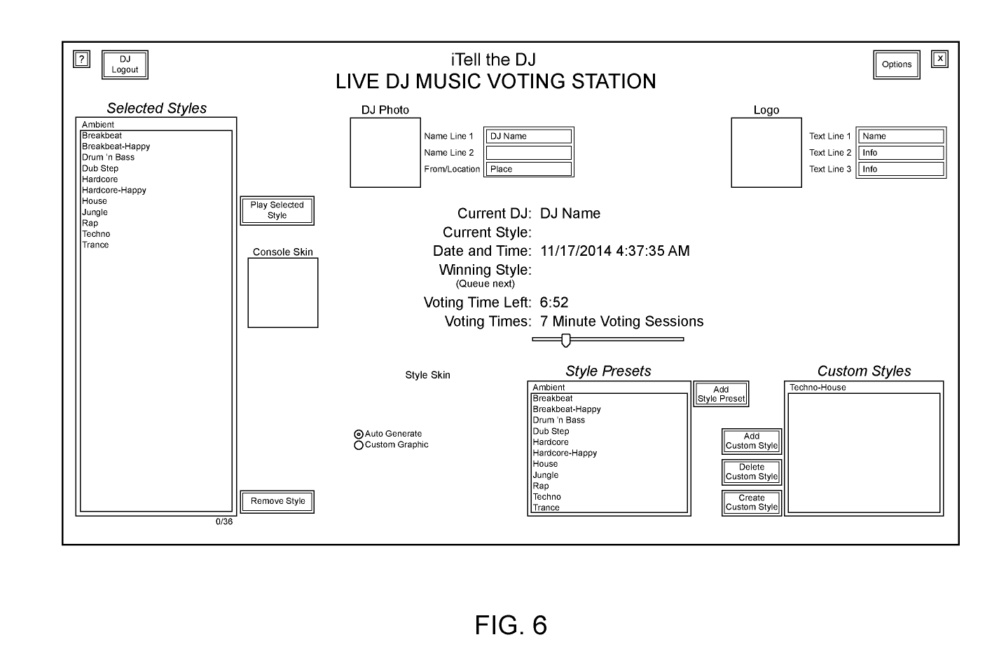

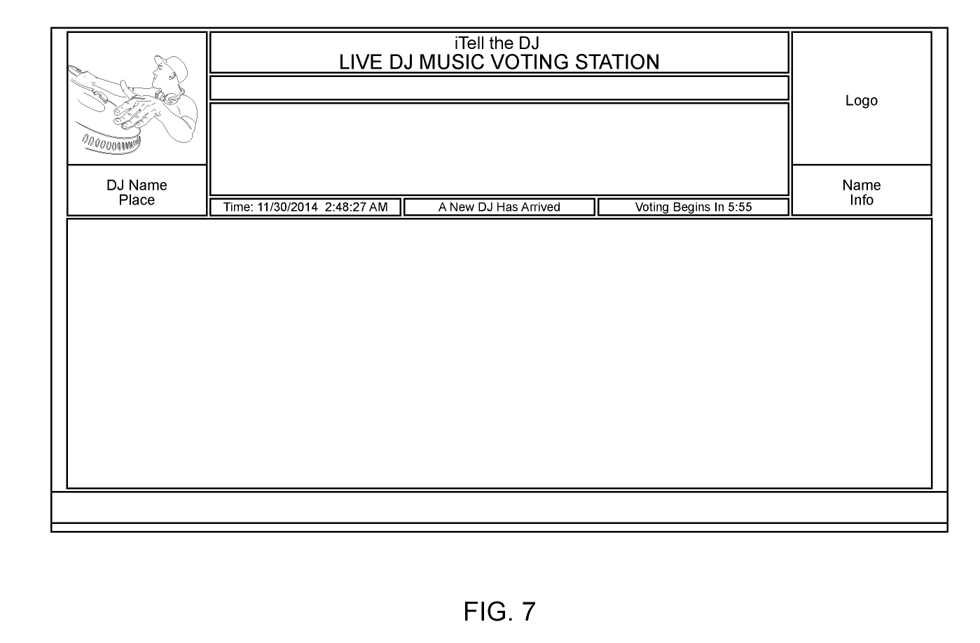

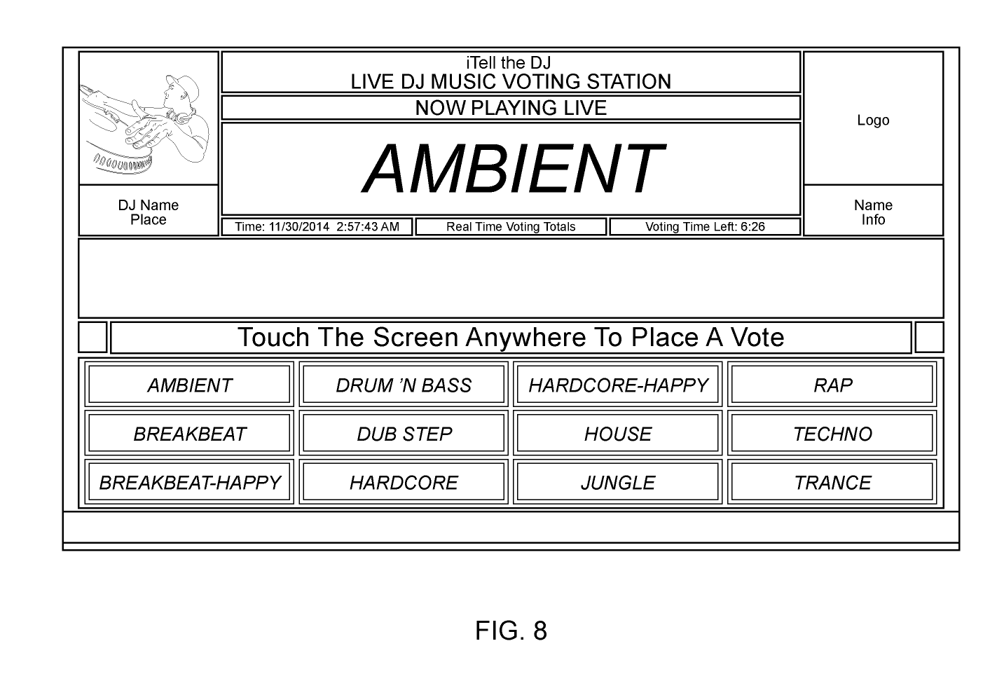

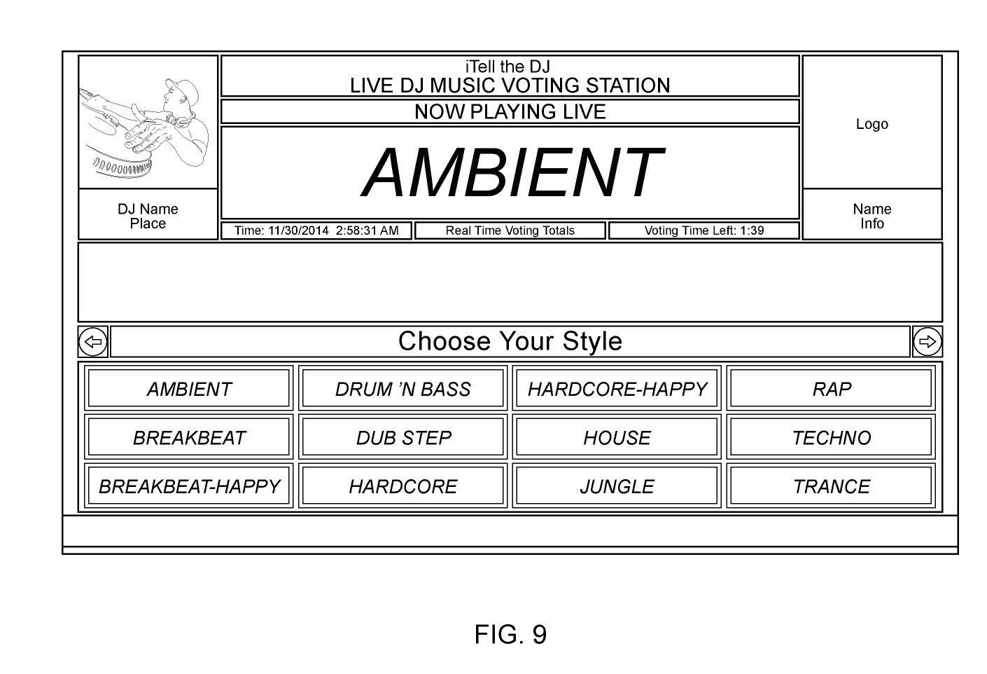

FIG. 5 is a screenshot illustrating a login screen for the DJ while he/she click on a “DJ login” icon in the welcome screen of the DJ musical playback software application 30 of the present invention. Upon clicking the “DJ login” icon the system 20 provides login or sign up options for the DJ. Further the system 20 prompts a password for login and after successful login the DJ is directed to the DJ control station screen. FIG. 6 is a screenshot illustrating the DJ control station screen after the successful login of the DJ in accordance with the present invention. The DJ control station screen then displays the name of the DJ logged in, DJ's photo, list available choices for presenting to the remote and the onsite audience and a voting session length timer. Minutes can be added or subtracted to the voting session in advance, or as needed by the DJ utilizing the voting session length timer. The minutes can be added by mouse clicking or touch screen tapping the visible on-screen counter, which will be decrementing one second at a time until the last minute, at which point tenths of a second will also be displayed after the whole number and decimal point. Minutes can be subtracted with a mouse “right-click” or equivalent touch screen tap that triggers a “right-click” function on the timer in DJ control station screen. FIGS. 7,8 and 9 are screenshots illustrating a welcome screen for the audience while he/she opening the DJ musical playback software application 30 utilizing a plurality of voting kiosk consoles 14 and 16 and the plurality of voting kiosk consoles screens during the voting session in accordance with the present invention respectively. During the voting session the system prompts the user to vote for at least one playlist from the presented choices of available music before the voting session elapses.

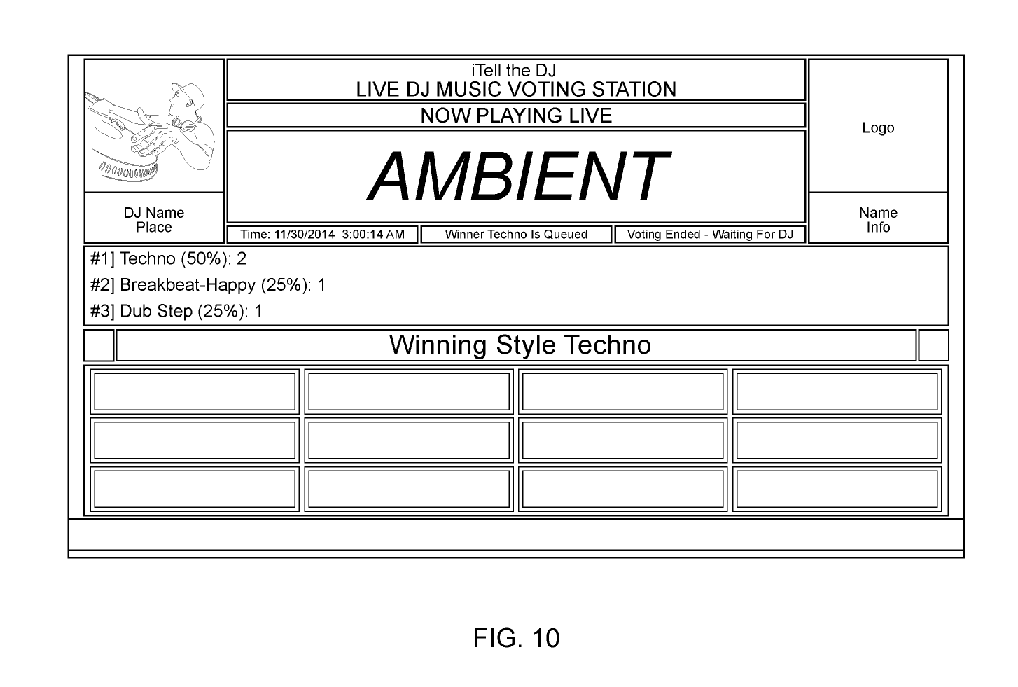

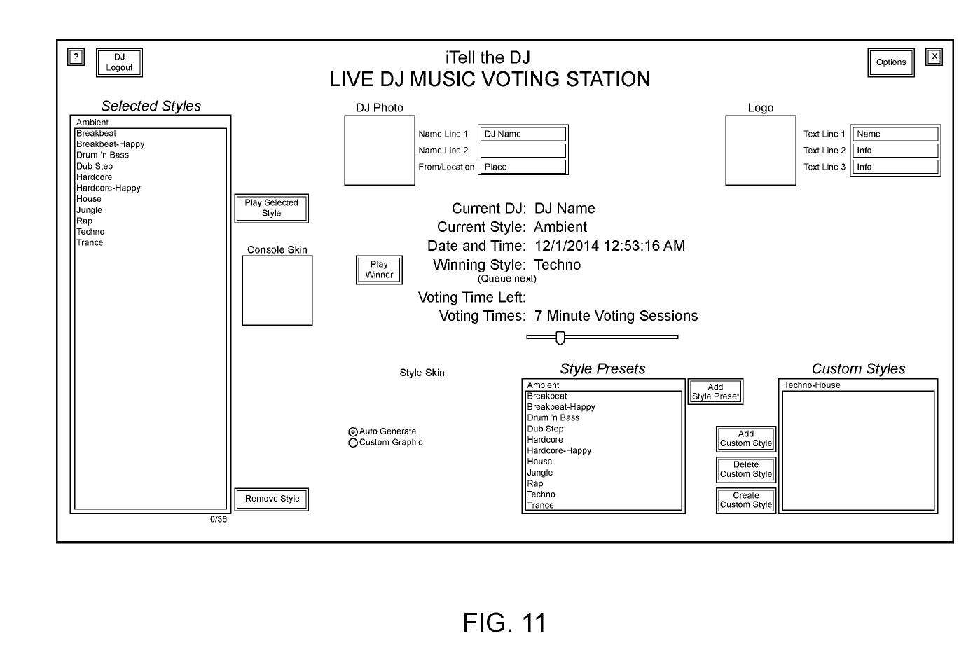

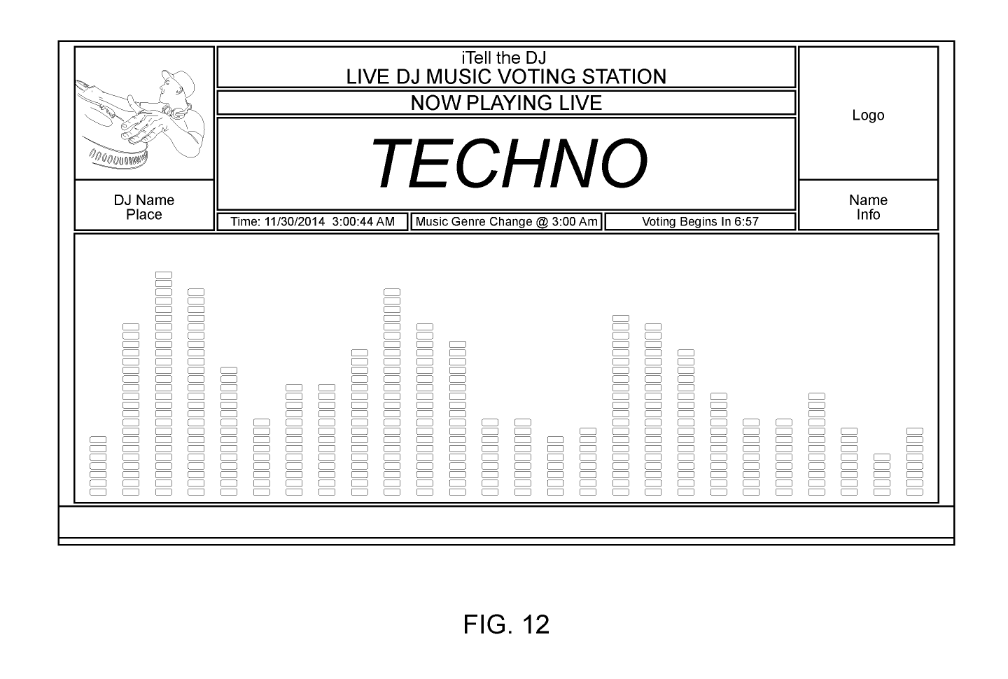

FIGS. 10 and 11 are screenshots illustrating the plurality of voting kiosk consoles screens and the DJ control station screen while displaying at least one winner playlist in accordance with the present invention respectively. While displaying the at least one winner playlist, a “play winner” option appears on the DJ control station screen and the DJ then cue up or prepare to perform the winner playlist and mix or blend it in when appropriate. FIG. 12 is a screenshot illustrating the plurality of voting kiosk console screens while playing the winner playlist with highest voting rates in accordance with the present invention in accordance with the present invention. If no votes were received from the onsite audience and the remote audience for the presented choice of available music, the DJ initiates a next voting session for an alternate choice of available music and the process repeats until the DJ performance ends. Further, a manual override is possible utilizing a “play selected style” function or the like, which plays the style of music that is selected by the DJ. Lastly, a “play winner” functionality or the like may be utilized once a winning playlist is chosen.

It should also be understood that the logic code, programs, modules, processes, methods and the order in which the respective processes of each method performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that may contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable storage medium may be transmitted using any appropriate medium, including but not limited to wireless, wire line, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products that are non-transitory according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for controlling musical playback from a human Disc Jockey (DJ) using a non-transitory computer program product being embodied in a computer readable medium, the method comprising:
a) enabling the DJ to log into a DJ musical playback software application utilizing a DJ interface module;
b) allowing the DJ to add or remove musical styles and genres to present at least one choice of available music for an onsite audience and a remote audience utilizing a DJ music style listing module;
c) presenting the choice of available music before the onsite audience and the remote audience utilizing a DJ choice presenting module;
d) allowing the DJ to set a voting session for the onsite audience and the remote audience utilizing a DJ music timer module;
e) enabling the onsite audience to vote for at least one music style from the presented choices of available music utilizing an onsite audience interface module;
f) enabling the remote audience to vote for at least one music style from the presented choices of available music utilizing a remote audience interface module;
g) automatically tallying the voting rates of each of the presented choice of available music utilizing a vote tallying module; and
h) displaying at least one winner playlist with highest voting rates to the DJ, the remote audience and the onsite audience utilizing a winner display module if the vote tallying module tally at least one vote.

2. The method of claim 1 wherein the presented choices of available music can be specifically identified by the name of the artist.

3. The method of claim 1 wherein the presented choices of available music can be specifically identified by the name of the music.

4. The method of claim 1 wherein the presented choices of available music can be displayed as graphical images behind text.

5. The method of claim 1 wherein the presented choices of available music can be displayed as text captioned on top of graphical images.

6. The method of claims 3 and 4 wherein graphical images and text can be altered, modified, processed, still-framed, or animated.

7. The method of claim 1 wherein the DJ initiates a next voting session for an alternate choice of available music if no votes were received from the onsite audience and the remote audience for the presented choice of available music.

8. A system for controlling musical playback from a human Disc Jockey (DJ) by retrieving an audience feedback, the system comprising:
a DJ control station;
a plurality of voting kiosk consoles, the plurality of voting kiosk consoles includes an onsite voting kiosk console and a remote voting kiosk console;
a DJ musical playback control system being in communication with the DJ control station and the plurality of voting kiosk consoles via a communication network, the DJ musical playback control system resides on a central computer having a processor installed with a DJ musical playback software application and coupled with a memory unit integrated with a central database, the DJ musical playback control system comprising:
a DJ interface module, at the processor, configured to enable a Disc Jockey to log into the DJ musical playback software application utilizing the DJ control station;
a DJ music style listing module, at the processor, configured to enable the DJ to add or remove musical styles and genres to present at least one choice of available music for an onsite audience and a remote audience utilizing the DJ control station;
a DJ choice presenting module, at the processor, configured to present the choice of available music before the onsite audience and the remote audience through an onsite voting kiosk console and a remote voting kiosk console respectively;
a DJ music timer module, at the processor, configured to enable the DJ to set a voting session for the onsite audience and the remote audience utilizing the DJ control station;
an onsite audience interface module, at the processor, configured to allow the onsite audience to vote for at least one music style from the presented choices of available music utilizing the onsite voting kiosk console;
a remote audience interface module, at the processor, configured to allow the remote audience to vote for at least one music style from the presented choices of available music through the remote voting kiosk console;
a vote tallying module, at the processor, configured to automatically tally the voting rates of each of the presented choice of available music; and
a winner display module, at the processor, configured to display at least one winner playlist with highest voting rates to the DJ, the remote audience and the onsite audience through the DJ control station, the remote voting kiosk console and the onsite voting kiosk console respectively if the vote tallying module tally at least one vote.

9. The system of claim 8 wherein the DJ control station, remote voting kiosk console and the onsite voting kiosk console are selected from a group consisting of: a smart phone, a laptop, a tablet computer, a personal computer and a digital media communication device.

10. The system of claim 8 wherein the presented choices of available music can be specifically identified by the name of the artist.

11. The system of claim 8 wherein the presented choices of available music can be specifically identified by the name of the music.

12. The system of claim 8 wherein the presented choices of available music can be displayed as graphical images behind text.

13. The system of claim 8 wherein the presented choices of available music can be displayed as text captioned on top of graphical images.

14. The system of claims 12 and 13 wherein graphical images and text can be altered, modified, processed, still-framed, or animated.

15. The system of claim 8 further includes a digital or electrical power signal outputted and controlled by the DJ musical playback software application that allows for the activation or de-activation of recorded or generated sounds, external lighting such as rotating beacons, strobes, digital or powered signs, or any other signal for informing the onsite audience of when the votes are being taken by the system.

16. The system of claim 8 wherein the DJ initiates a next voting session for an alternate choice of available music if no votes were received from the onsite audience and the remote audience for the presented choice of available music.

17. A non-transitory computer-readable medium having a computer-readable program code embodied therein which when executed by a computer having a processor installed with a DJ musical playback software application and coupled with a memory unit integrated with a central database causes the processor to perform the following steps:
a) enabling the DJ to log into a DJ musical playback software application utilizing a DJ interface module through a DJ control station;
b) allowing the DJ to add or remove musical styles and genres to present at least one choice of available music for an onsite audience and a remote audience utilizing a DJ music style listing module through the DJ control station;
c) presenting the choice of available music before the onsite audience and the remote audience utilizing a DJ choice presenting module through an onsite voting kiosk console and a remote voting kiosk console respectively;
d) allowing the DJ to set a voting session for the onsite audience and the remote audience utilizing a DJ music timer module through the DJ control station;
e) enabling the onsite audience to vote for at least one music style from the presented choices of available music utilizing an onsite audience interface module through the onsite voting kiosk console;
f) enabling the remote audience to vote for at least one music style from the presented choices of available music utilizing a remote audience interface module through the remote voting kiosk console;
g) automatically tallying the voting rates of each of the presented choice of available music utilizing a vote tallying module; and
h) displaying the winner playlists with highest voting rates to the DJ, the remote audience and the onsite audience utilizing winner display module through the DJ control station, the remote voting kiosk console and the onsite voting kiosk console respectively if the vote tallying module tally at least one vote.

18. The method of claim 17 wherein the DJ control station, remote voting kiosk console and the onsite voting kiosk console are selected from a group consisting of: a smart phone, a laptop, a tablet computer, a personal computer and a digital media communication device.

19. The method of claim 17 wherein the DJ musical playback software application outputs and controls a digital or electrical power signal by that allows for the activation or de-activation of recorded or generated sounds, external lighting such as rotating beacons, strobes, digital or powered signs, or any other signal for informing the onsite audience of when the votes are being taken by the system.

20. The method of claim 17 wherein the DJ initiates a next voting session for an alternate choice of available music if no votes were received from the onsite audience and the remote audience for the presented choice of available music.
